(19) United States
(12) Patent Application Publication
(10) Pub. No.: US 2026/0147825 A1
(43) Pub. Date: May 28, 2026

(54) GENERATING DIVERSE CONTENT RELATIONSHIP TABLES BASED ON GENERATIVE ARTIFICIAL INTELLIGENCE (AI) MODEL QUERIES

(71) Applicant: Microsoft Technology Licensing, LLC, Redmond, WA (US)

(72) Inventors: Sedigheh ZOLAKTAF, Vancouver (CA); Kamal GINOTRA, Kirkland, WA (US); Dongfei YU, Vancouver (CA); Mikhail PANFILOV, Bothell, WA (US); Mahdi HAJIAGHAYI, Kirkland, WA (US); Andrew James MCNAMARA, Belwood (CA)

(21) Appl. No.: 18/962,969

(22) Filed: Nov. 27, 2024

(51) Int. Cl. G06F 16/51; G06F 16/583

(52) U.S. Cl. CPC G06F 16/51; G06F 16/583

(57) ABSTRACT

This disclosure describes a real-time diverse content retrieval system (diverse retrieval system for short) that utilizes a generative artificial intelligence (AI) model to create diverse content relationship tables corresponding to candidate content items. For instance, the diverse retrieval system leverages generative AI models to create diverse image search queries related to candidate images. The diverse retrieval system can use the diverse image search queries to identify a select set of effective and advantageous images. Furthermore, the diverse retrieval system can generate a diverse image relationship table that maps candidate images to the selected set of images. By doing so, the diverse retrieval system can provide a diverse set of related images in real time in response to an image retrieval request for the image.

### BACKGROUND

Recent years have seen significant growth in both hardware and software in the field of content discovery systems. These systems, which provide personalized content to users, have become integral to enhancing user experiences across various digital platforms. Typically, they leverage algorithms that analyze user data to predict and deliver content tailored to individual preferences. However, despite advancements in machine learning and data processing techniques, current content discovery systems still encounter several technical shortcomings. For example, real-time processing limitations can lead to delays in delivering content to users within an acceptable timeframe. These issues, along with others described below, underscore the urgent need for improvements in both efficiency and accuracy within current content discovery systems.

### BRIEF DESCRIPTION OF THE DRAWINGS

The following detailed description provides specific and detailed implementations accompanied by drawings. Additionally, each of the figures listed below corresponds to one or more implementations discussed in this disclosure.

FIG. 1 illustrates an example overview of implementing a diverse retrieval system that uses a generative artificial intelligence (AI) model to generate a diverse image relationship table.

FIG. 2 illustrates an example computing environment in which the diverse retrieval system is implemented in a cloud computing system.

FIG. 3 illustrates an example diagram for selecting candidate images for further processing.

FIG. 4A illustrates an example sequence flow diagram for generating diverse image search queries.

FIG. 4B illustrates an example image query generation prompt.

FIG. 5 illustrates an example sequence flow diagram for obtaining a selected set of images corresponding to a candidate image.

FIG. 6 illustrates an example diagram of an image-to-image diverse image relationship table that maps a candidate image to the selected set of images.

FIG. 7 illustrates an example state diagram for using the diverse image relationship table to retrieve selected images mapped to a content item in response to an image retrieval request.

FIGS. 8A-8B illustrate example for selected image search results of a candidate image and of providing selected images mapped to a candidate image within a graphical user interface in response to an image retrieval request.

FIG. 9 illustrates an example series of acts in a computer-implemented method for generating one or more image relationship tables using one or more generative artificial intelligence (AI) models.

FIG. 10 illustrates example components included within a computer system for implementing a diverse retrieval system.

### DETAILED DESCRIPTION

This disclosure describes a real-time diverse content retrieval system (diverse retrieval system for short) that utilizes a generative artificial intelligence (AI) model to create diverse content relationship tables corresponding to candidate content items. For instance, the diverse retrieval system leverages generative AI models to create diverse image search queries related to candidate images. The diverse retrieval system can use the diverse image search queries to identify a select set of effective and advantageous images. Furthermore, the diverse retrieval system can generate a diverse image relationship table that maps candidate images to the selected set of images. By doing so, the diverse retrieval system can provide a diverse set of related images in real time in response to an image retrieval request for the image.

Indeed, implementations of the present disclosure provide benefits and solve various problems in the art with systems, computer-readable media, and computer-implemented methods that utilize a diverse retrieval system to quickly, efficiently, and accurately provide diverse images or other content using a diverse content relationship table in response to an image retrieval request. Notably, while the diverse retrieval system is described in terms of candidate images and mapped images, the same principles, operations, and actions correspond to other types of content items.

As mentioned above, current content discovery systems suffer from several technical shortcomings that hinder their effectiveness. A significant issue is the rigidity of many existing systems, which limits the variety of content they can provide to users. For example, when a user submits a query or when another system provides a content retrieval request, many content discovery systems struggle to offer a diverse selection of relevant content. This limitation arises from the need to deliver results within a constrained timeframe, which prevents the systems from quickly identifying and retrieving a broad range of options. Consequently, many content discovery systems provide inaccurate results in the form of repetitive or irrelevant suggestions.

In an attempt to address these challenges, some content delivery systems have adopted more complex models for content discovery. For instance, generative models are employed to tailor content to specific users. However, these models often introduce their own set of problems. They tend to be overly complex, resulting in slower response times that are unsuitable for real-time applications. Additionally, the computational demands of these models can lead to inefficiencies, particularly when executed on demand. As a result, they frequently fall short of delivering effective online content discovery and retrieval, leaving users frustrated and underserved.

In contrast to existing systems, as described in this disclosure, the diverse retrieval system delivers several significant technical benefits in terms of computing accuracy and efficiency. Moreover, the diverse retrieval system provides several practical applications that address problems related to accurately, flexibly, and efficiently providing content (e.g., images) for users in response to an image retrieval request.

To illustrate, the diverse retrieval system offers several technical benefits, including improved efficiency, accuracy, and flexibility in diverse image retrieval. As mentioned, the diverse retrieval system creates a diverse image relationship table (or diverse content relationship table) for candidate images (or other candidate content). By generating and utilizing this diverse image relationship table, the diverse retrieval system provides various technical improvements.

For example, the diverse image relationship table facilitates a relevant and safe set of images corresponding to a content image. Given an image identifier (or other content identifier) that matches a candidate image, the diverse retrieval system can access and provide an accurate and varied set of images previously mapped to that candidate image. Indeed, the mapped images can be automatically curated to include both useful and aesthetically pleasing options.

In many implementations, the diverse retrieval system utilizes a generative artificial intelligence (AI) model, such as a visual-based generative AI model, to generate a set of diverse image search queries corresponding to a candidate image. Notably, the system leverages one or more generative AI models while offline to reduce computational demands. These diverse image search queries are then used to discover a range of images, some of which are stored in the diverse image relationship table for the candidate image. By generating the diverse image relationship table offline, the diverse retrieval system can quickly retrieve this diverse set of images in real time, with minimal computational cost.

As illustrated in the foregoing discussion, this disclosure utilizes a variety of example terms to describe the features and advantages of one or more implementations. For instance, this disclosure describes the diverse retrieval system in the context of a cloud computing system. As an example, the term “cloud computing system” refers to a network of interconnected computing devices that provide various services and applications to computing devices (e.g., server devices and client devices) inside or outside of the cloud computing system. While various components are described as belonging to a cloud computing system, in some implementations, one or more components may be located outside of the cloud computing system. Additional terms are defined throughout the document in different examples and contexts.

As an example, the term “image” refers to a digital graphics file that, when rendered, displays one or more objects. Images may be grouped into sets or collections based on various associations. Images can include a candidate image (e.g., an image that may be retrieved by an image discovery or retrieval system) and a mapped image (e.g., an image mapped to a candidate image within a diverse image relationship table). As another example, the term “diverse image” refers to one or more images that are semantically related but visually different from a target image. As another example, the term “image identifier” refers to a unique label or tag associated with an image.

As an example, the term “generative artificial intelligence model” (or “generative AI model”) refers to an artificial intelligence computational system that utilizes deep learning and a large number of parameters (e.g., in the billions or trillions for a large version and fewer for a small version) that are trained on one or more extensive datasets to produce coherent, contextually relevant, and fluent topic-specific outputs (e.g., text and/or images). In many instances, a generative AI model refers to an advanced computational system that uses natural language processing, machine learning, and/or image processing to generate coherent and contextually relevant human-like responses. For example, a generative AI image model is a generative AI model that specializes in creating generative images

Generative AI models have applications in natural language understanding, content generation, text summarization, dialogue systems, language translation, creative writing assistance, image generation, audio generation, and more. A single generative AI model often performs a wide range of tasks by receiving different inputs, such as prompts (e.g., input instructions, rules, example inputs, example outputs, and/or tasks), data, and/or access to data. In response, the generative AI model generates various output formats, ranging from one-word answers to long narratives, images and videos, labeled datasets, documents, tables, and presentations.

Moreover, generative AI models are primarily based on transformer architectures for understanding, generating, and manipulating human language. Generative AI models can also utilize other types of architectures such as recurrent neural network (RNN) architectures, long short-term memory (LSTM) model architectures, or convolutional neural network (CNN) architectures. Examples of generative AI models include generative pre-trained transformer (GPT) models like GPT-3.5, GPT-4, and GPT-40; bidirectional encoder representations from transformers (BERT) models; text-to-text transfer transformer models like T5; conditional transformer language (CTRL) models; and Turing-NLG. Other types of generative AI models include sequence-to-sequence models (Seq2Seq), vanilla RNNs, and LSTM networks. In some instances, a generative AI model includes a large language model (LLM), a small language model (SLM), and a small action model (SAM), which serves as a text-based version of a generative AI model that receives text prompts and/or generates text outputs. In various implementations, a generative AI model may be a multimodal generative model that receives multiple input formats (e.g., text, images, video, data structures) and/or generates multiple output formats.

Generative AI models also include visual-based generative AI models. Visual-based generative AI models generate visual image grounding information from an input image. For instance, a visual-based generative AI model could use a combination of convolutional neural networks (CNNs) and transformers to generate high-quality visual content and/or extract visual features from the input image.

As another example, the terms “prompt,” “model prompt,” or “generative AI model prompt” refer to a request provided to a large generative image model to create generative AI model output based on plain language guidance prompts. In various instances, the prompt is an image query generation prompt requesting the creation of a set of diverse image search queries associated with a candidate image.

As another example, the terms “query response” or “response” refer to the generated output produced by a generative AI model (e.g., a visual-based generative AI model) in reaction to a given prompt. A response can take various forms, such as natural language text, images, or other structured data. In various implementations, a generative AI model generates a set of diverse image search queries corresponding to a candidate image.

As another example, the term “diverse content relationship table” refers to a data structure that maps a target content item to one or more related content items (e.g., images). A diverse content relationship table can also include metadata, queries, and/or other data associated with the related content items mapped to the target content item. A diverse content relationship table can map content items of the same type (e.g., image-to-image relationships). In some instances, a diverse content relationship table maps content items of different types (e.g., query-to-image or website-to-image).

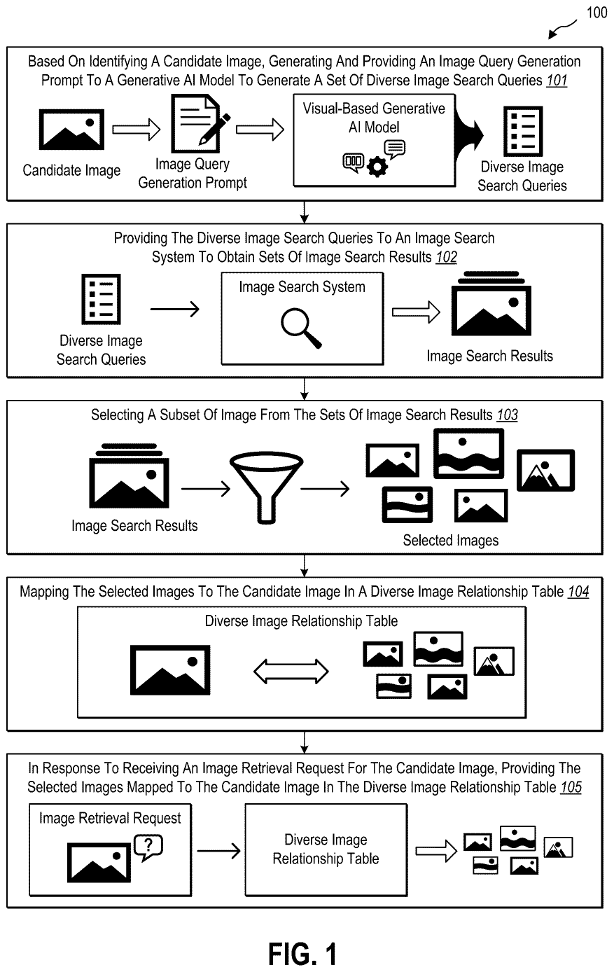

Additional example implementations and details of the diverse retrieval system are discussed in connection with the accompanying figures, which are described next. For example, FIG. 1 illustrates an example overview of implementing a diverse retrieval system that uses a generative artificial intelligence (AI) model to generate a diverse image relationship table according to some implementations. As shown, FIG. 1 illustrates a series of acts 100 performed (or caused to be performed) by the diverse retrieval system.

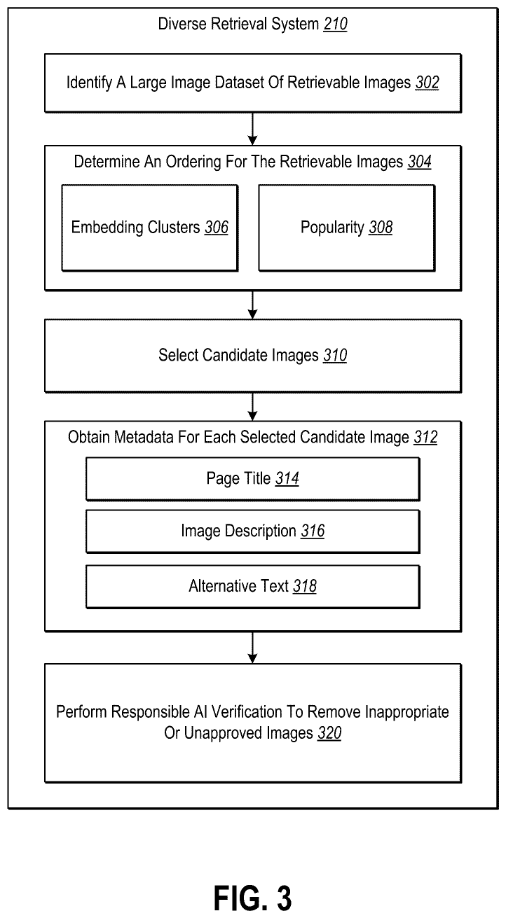

As shown, the series of acts 100 includes act 101 of generating and providing an image query generation prompt to a generative AI model to generate a set of image search queries based on identifying a candidate image. For example, the diverse retrieval system uses one or more approaches to identify and select candidate images. Additional details about selecting candidate images are provided in connection with FIG. 3 below.

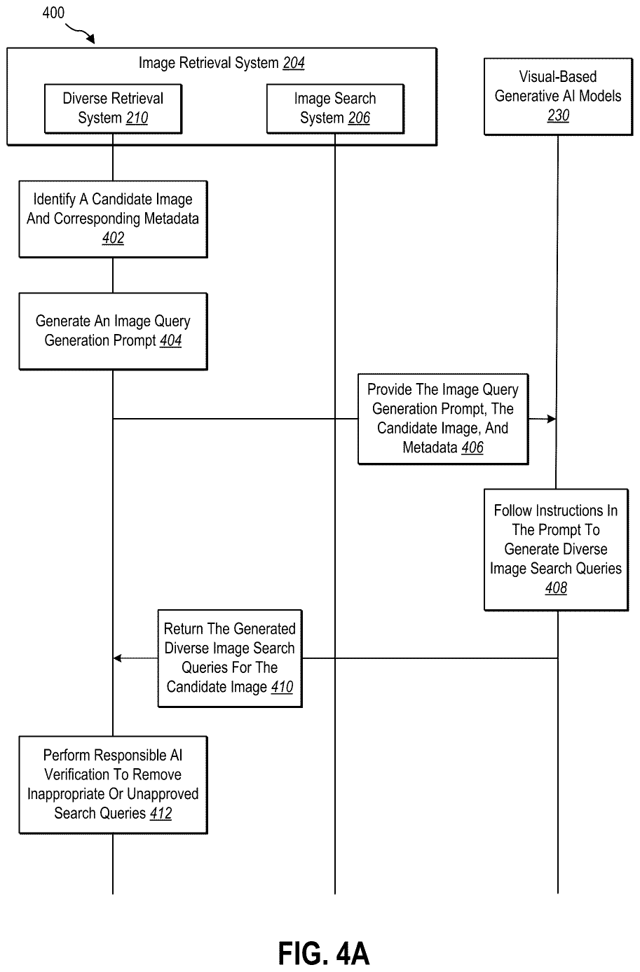

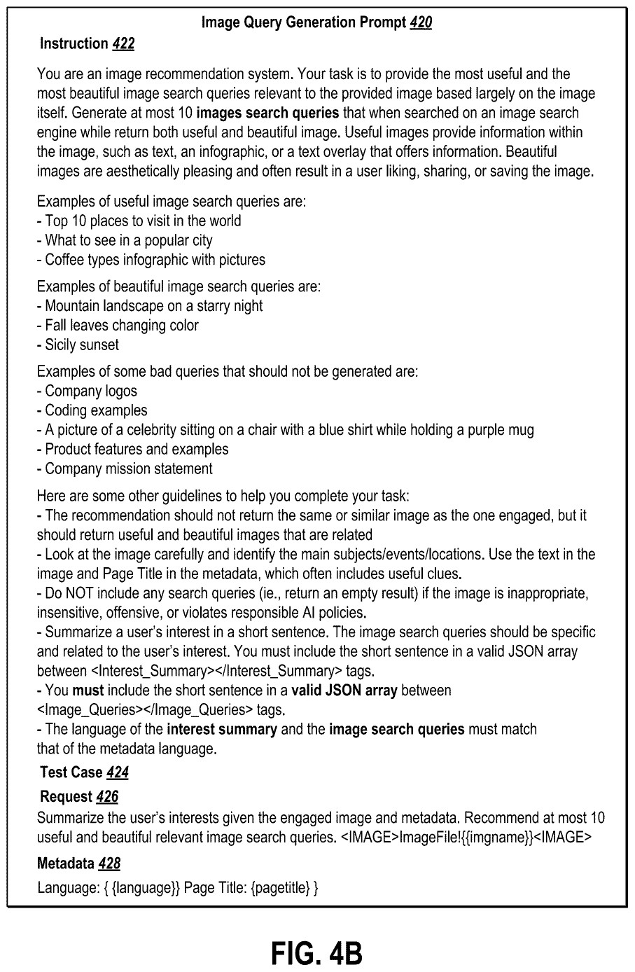

Furthermore, the diverse retrieval system provides the candidate image along with an image query generation prompt to a generative AI model. For example, the diverse retrieval system provides an image query generation prompt instructing the generative AI model to generate ten diverse image search queries. In various implementations, the generative AI model is a visual-based generative AI model. In various implementations, the diverse retrieval system provides additional contextual information to the generative AI model. In response to receiving the prompt, the generative AI model generates a set of diverse image search queries. Additional details about generating diverse image search queries are provided in connection with FIGS. 4A-4B below.

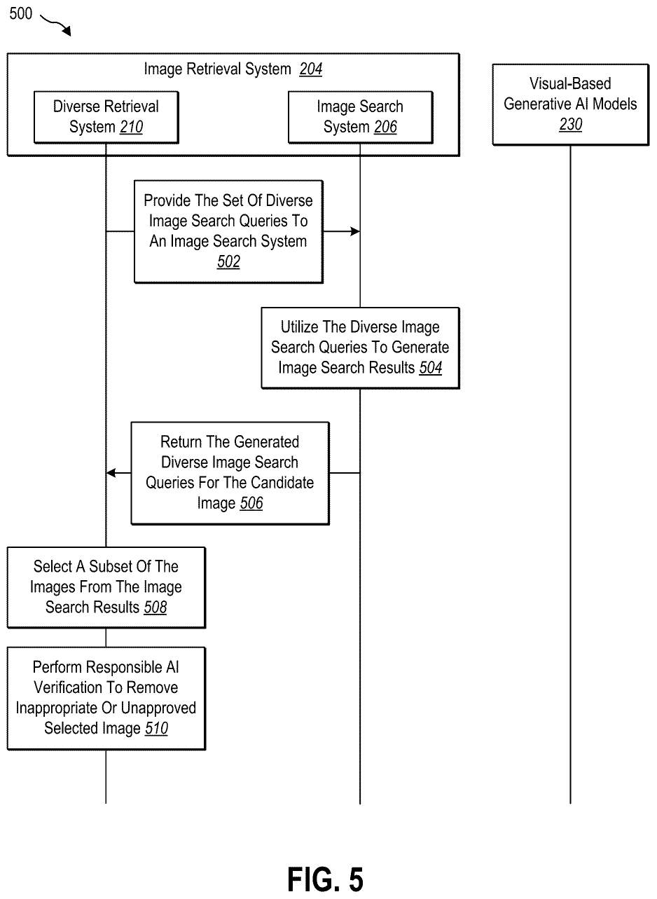

Act 102 includes providing the diverse image search queries to an image search system to obtain sets of image search results. For example, the diverse retrieval system provides the set of diverse image search queries to an image search system, which applies each of the queries to discover corresponding sets of images (e.g., image search results). Because the image search queries cover a diverse assortment of content, the resulting image search results will represent the candidate image in a diverse manner. Additional details about discovering image search results are provided in connection with FIG. 5 below.

Act 103 includes selecting a subset of images from the set of image search results. For instance, the diverse retrieval system selects a limited number of images from each image search result set. For example, if the image search system performs ten image searches based on ten provided diverse image search queries, the diverse retrieval system may select 25 images from each of the search results (for a total of 250 images). Additional details about selecting a subset of search result images are provided in connection with FIG. 5 below.

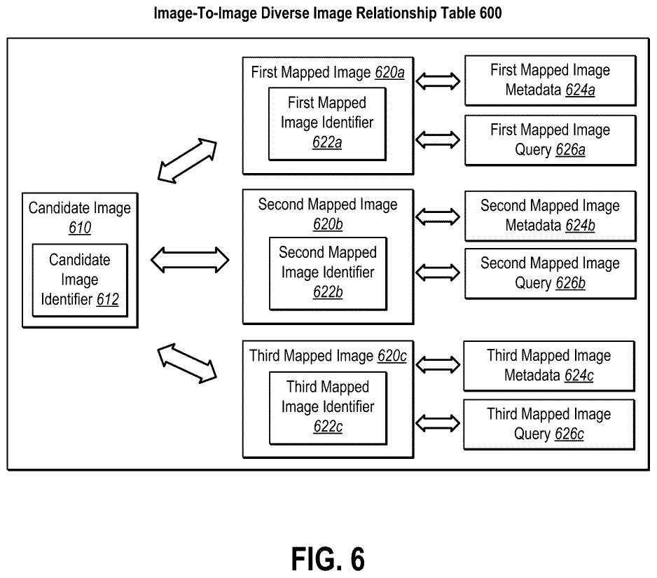

Act 104 includes mapping the selected images to the candidate image in a diverse image relationship table. For instance, the diverse retrieval system generates and/or updates a diverse image relationship table that includes a mapping between the candidate image and the selected search result images. In some implementations, the diverse retrieval system also includes metadata, queries, and/or other data associated with the selected search result images. The diverse image relationship table may reside within an image relationship database. While an image-to-image relationship table is shown, the relationship table may map queries, websites, or other content types to the selected images. Additional details about generating a diverse image relationship table are provided in connection with FIG. 6 below.

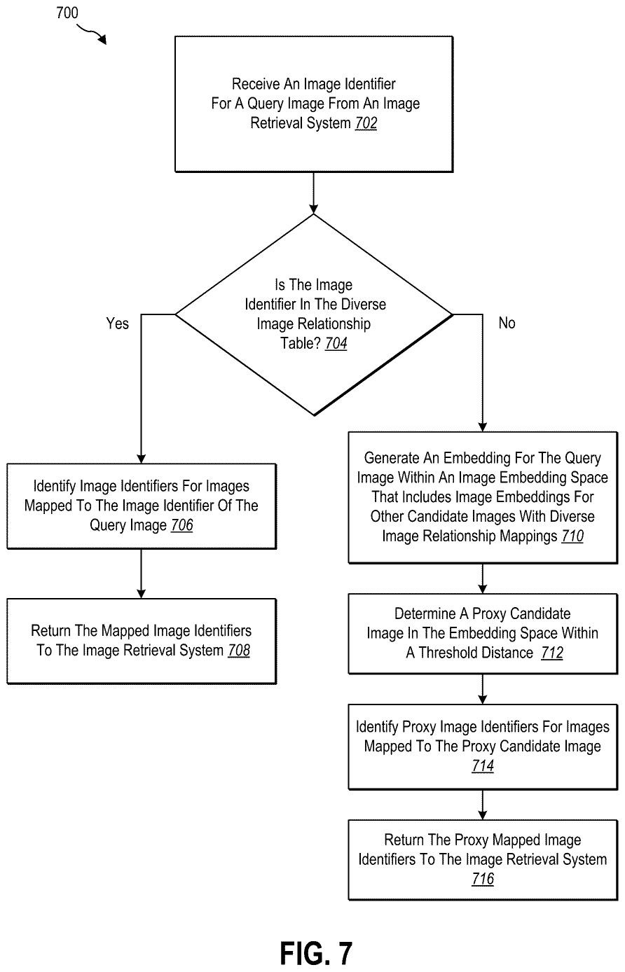

Act 105 includes providing the selected images mapped to the candidate image in the diverse image relationship table in response to receiving an image retrieval request for the candidate image. In one or more implementations, the diverse retrieval system receives an image retrieval request that identifies the candidate image (e.g., via an image identifier). In response, the diverse retrieval system accesses the diverse image relationship table for the candidate image to retrieve the selected images mapped to the candidate image. The diverse retrieval system can then provide one or more of the selected images in response to the retrieval request. Additional details about utilizing diverse image relationship tables are provided below in connection with FIG. 7.

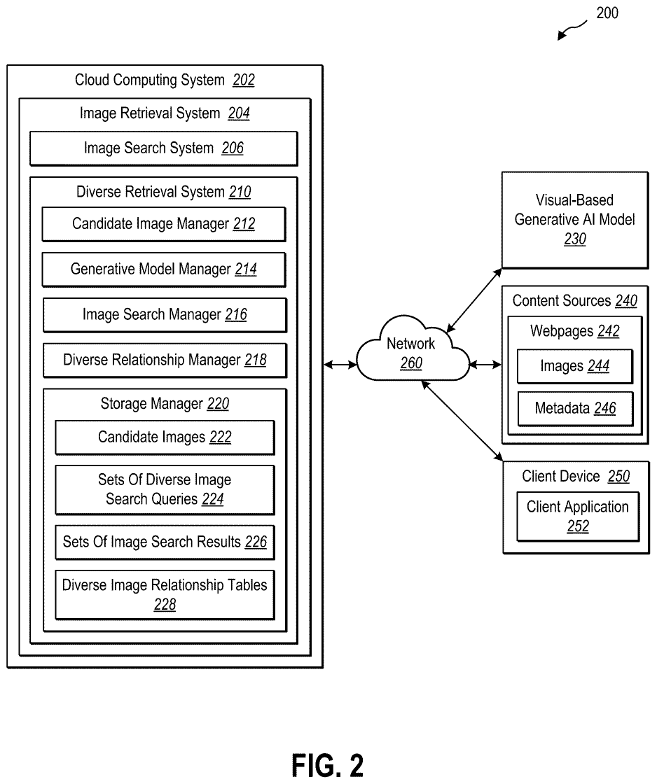

With a general overview in place, the next figure provides a general overview of the components, features, and elements of the diverse retrieval system. To illustrate, FIG. 2 shows an example computing environment where the diverse retrieval system is implemented in a cloud computing system according to some implementations. In particular, FIG. 2 shows an example of a computing environment 200 with various computing devices within a cloud computing system 202 associated with a diverse retrieval system 210. While FIG. 2 shows example arrangements and configurations of the computing environment 200, the cloud computing system 202, the diverse retrieval system 210, and associated components, other arrangements and configurations are possible.

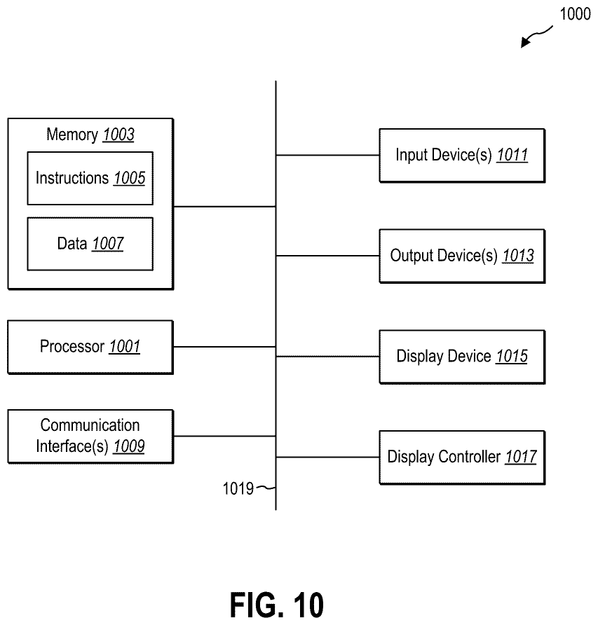

As shown, the computing environment 200 includes a cloud computing system 202, a visual-based generative AI model 230, content sources 240, and a client device 250 connected via a network 260. The cloud computing system 202 includes an image retrieval system 204 with an image search system 206 and a diverse retrieval system 210 (e.g., a real-time diverse image or content retrieval system). Each of these systems and/or components may be implemented on one or more computing devices, such as on a set of one or more server devices. Further details regarding computing devices are provided below in connection with FIG. 10, along with additional details about networks, such as the network 260 shown.

The image retrieval system 204 performs a variety of functions. In various implementations, the image retrieval system 204 facilitates the discovery, retrieval, and delivery of images (and, in some cases, other content). In various implementations, the image retrieval system 204 retrieves and provides content in response to a system or user request. For example, the image retrieval system 204 facilitates users providing query requests to the cloud computing system 202 and handles the query request using the image search system 206 and/or the diverse retrieval system 210. The image retrieval system 204 may also implement one or more user interfaces for users to communicate with the components and systems of the cloud computing system 202.

As shown, the image retrieval system 204 implements the image search system 206 (e.g., an image search engine) and the diverse retrieval system 210. In various implementations, the image search system 206 facilitates discovering images based on system or user queries. In particular, the image search system 206 obtains image search results in response to executing image queries. In various implementations, the image search system 206 indexes search results to improve the efficiency of future searches. In some instances, the image search system 206 works with the diverse retrieval system 210 to save previous search results for later retrieval.

Before describing the components of the diverse retrieval system 210, other components of the computing environment 200 are first discussed. As shown, the cloud computing system 202 includes the visual-based generative AI model 230, which generates comprehensive grounding information from images. For instance, the visual-based generative AI model uses a combination of convolutional neural networks (CNNs) and transformers to generate high-quality visual content and/or extract visual features from the input image. The visual-based generative AI model 230 also determines varying levels of image descriptions and grounding information from an input image.

Additionally, the cloud computing system 202 includes content sources 240. The content sources 240 may include webpages 242 having images 244 and metadata 246. In some implementations, a content source includes a database of images. Content sources can include various types of data repositories that include images 244.

As shown, the computing environment 200 includes the client device 250. In various implementations, the client device 250 is associated with a user (e.g., a user client device), such as a user who interacts with the image retrieval system 204 to request and receive diverse images. For example, the client device 250 includes a client application 252, such as a web browser or another form of computer application for accessing and/or interacting with the image retrieval system 204 and/or the diverse retrieval system 210 via the network 260.

Returning now to the diverse retrieval system 210, which is shown implemented within the image retrieval system 204. In some implementations, the diverse retrieval system 210 is located on a separate computing device from the image retrieval system 204 within the cloud computing system 202. For example, the diverse retrieval system 210 is on another server device, or the diverse retrieval system 210 is located wholly or in part on the client device 250.

As shown, the diverse retrieval system 210 includes various components and elements, which are implemented in hardware and/or software. For example, the diverse retrieval system 210 includes a candidate image manager 212, a generative model manager 214, an image search manager 216, a diverse relationship manager 218, and a storage manager 220. The storage manager 220 includes candidate images 222, sets of diverse image search queries 224, sets of image search results 226, and diverse image relationship tables 228.

In various implementations, the candidate image manager 212 manages the selection of candidate images 222. For example, the candidate image manager 212 selects a set of the candidate images 222 from the images 244 on the webpages 242. The candidate image manager 212 can also retrieve metadata 246 for the candidate images 222 that are selected, which is further described below.

In some instances, the generative model manager 214 interacts with the visual-based generative AI model 230 to generate the sets of diverse image search queries 224. For example, the generative model manager 214 provides image query generation prompts, candidate images 222, and corresponding metadata to the visual-based generative AI model 230 and receives image query generation prompts in response, which is further described below.

In one or more implementations, the image search manager 216 interacts with the image search system 206 to obtain sets of image search results 226. For example, the image search manager 216 provides the sets of diverse image search queries 224 to the image search system 206, which executes the search queries to identify the sets of image search results 226. In some implementations, the sets of diverse image search queries 224 include images from the content sources 240. In various implementations, the image search manager 216 also selects a subset of images from the sets of diverse image search queries 224, which is further described below.

In various implementations, the diverse relationship manager 218 generates, updates, and/or maintains the diverse image relationship tables 228. For example, the diverse relationship manager 218 generates mappings between selected candidate images and corresponding selected images from the search results. The diverse relationship manager 218 may also use the diverse image relationship tables 228 to provide real-time image retrieval results in response to retrieval requests.

As noted above, FIG. 3 through FIG. 7 provide example diagrams of operations and actions of the diverse retrieval system 210 for generating and utilizing diverse image relationship tables for candidate images. To begin, FIG. 3 provides additional details about selecting candidate images. In particular, FIG. 3 illustrates an example diagram for selecting candidate images for further processing according to some implementations.

As shown in FIG. 3, the diverse retrieval system 210 includes a series of acts for selecting candidate images. The series begins with act 302 of identifying a large image dataset of retrievable images. For example, the diverse retrieval system 210 accesses a repository of images that may be retrievable by the image search system. In some instances, the image repository includes a database of indexed images from content sources across the Internet. Additionally, the large image dataset of retrievable images may constantly be updated to add newly discovered images and drop or remove removed images.

Act 304 includes determining an ordering for the retrievable images. In general, the diverse retrieval system 210 determines an organization scheme for the identified images. For instance, the diverse retrieval system 210 parses the large image dataset and determines an order for the images in the dataset.

As shown, act 304 can include determining an ordering based on embedding clusters 306 or popularity 308. For example, in some implementations, the diverse retrieval system 210 generates maps of images in the dataset to embedding space and applies one or more clustering algorithms to generate cluster groups. Based on cluster size and embedding space location, the diverse retrieval system 210 can order the images. For example, the diverse retrieval system 210 prioritizes larger clusters and/or clusters located within a threshold proximity of each other. In some implementations, the diverse retrieval system 210 selects one or more representative images for a cluster when ordering (e.g., ranking) images in the dataset.

In one or more implementations, the diverse retrieval system 210 utilizes popularity to order images in the dataset. For instance, the diverse retrieval system 210 identifies image characteristics, such as the number of times an image was called (e.g., access count), retrieved, selected (e.g., clicked), referenced, shared, and/or other interaction factors. In these implementations, the diverse retrieval system 210 may order the images based on one or more image characteristics. For example, the diverse retrieval system 210 orders or ranks the images based on selection and/or search result appearance counts.

In some implementations, the diverse retrieval system 210 considers additional image characteristics when determining an ordering. For example, the diverse retrieval system 210 combines image freshness and/or recency with other factors to determine image ordering. Additionally, in some implementations, the diverse retrieval system 210 may periodically update the order or perform reordering.

Act 310 includes selecting candidate images. For example, the diverse retrieval system 210 selects the top-n images based on the ordering. In various implementations, the diverse retrieval system 210 continually selects candidate images. For instance, the diverse retrieval system 210 selects the 50 images for processing in the first round, followed by the top 50 images in each subsequent round.

Act 312 includes obtaining metadata for each selected candidate image. For example, upon selecting a content item, the diverse retrieval system 210 obtains the metadata associated with the image. Metadata can include image characteristics (e.g., source link, creation date, dimensions, color scheme). Additionally, metadata can include a page title 314 of the webpage on which an image is located (if located on a webpage). An image description 316 (parsed or generated), alternative text 318 (parsed or generated), or other metadata associated with the image may be included.

Act 320 includes performing responsible AI verification to remove inappropriate or unapproved images. For example, the diverse retrieval system 210 filters out and removes images that violate policies, disregard safety, promote improper bias, and/or otherwise have a negative impact. The diverse retrieval system 210 may also remove images that are unauthorized or include unauthorized or unapproved content.

As described above, FIGS. 4A-4B correspond to generating diverse image search queries. In particular, FIG. 4A illustrates an example sequence flow diagram for generating diverse image search queries and FIG. 4B illustrates an example image query generation prompt according to some implementations.

As shown, FIG. 4A includes communications between the diverse retrieval system 210 of the image retrieval system 204 and the visual-based generative AI model 230 to generate diverse image search queries. More specifically, FIG. 4A includes a series of acts 400 for actions performed by the diverse retrieval system 210 or the visual-based generative AI model 230 (following the directions of the diverse retrieval system 210).

The series of acts 400 includes act 402 of the diverse retrieval system 210 identifying a candidate image and the corresponding metadata. As described above, the diverse retrieval system 210 selects a candidate image along with its corresponding metadata. While the series of acts is described with respect to a single candidate image, the diverse retrieval system 210 can repeat the series of acts for additional candidate images (in sequence or in parallel).

Act 404 includes the diverse retrieval system 210 generating an image query generation prompt. In various implementations, the diverse retrieval system 210 generates a prompt for a generative AI model (e.g., a visual-based generative AI model) that includes instructions on how to generate a set of diverse image search queries. In some implementations, the prompt includes several diverse image search queries to generate a candidate image.

In various implementations, the prompt includes contextual information, providing the generative AI model with the perspective of acting as an image retrieval or recommendation system. The prompt can also provide positive and negative examples of image search query results. The prompt, or a supplemental prompt (e.g., a system prompt), can also include responsible AI safeguards and/or guidelines.

An example image query generation prompt is shown in FIG. 4B. As shown, FIG. 4B includes an image query generation prompt 420 having instructions 422. As shown in the example instructions 422, the diverse retrieval system 210 can include initial context and directives. The instructions 422 can also include examples of positive results and negative results. Additionally, the instructions 422 can include guidelines and tips for the model to complete the requested task.

As shown, the diverse retrieval system 210 instructs a generative AI model to generate ten image search queries (or another specified number) that, when searched on an image search engine (e.g., an image search system), will return both useful and beautiful images. The instructions 422 then provide a definition of useful images as those that provide information within an image, such as text, an infographic, or a text overlay that offers information. Additionally, the instructions 422 provide a definition of beautiful images as those that are aesthetically pleasing and often result in a user liking, sharing, or saving the image. To supplement these definitions, the instructions 422 provide examples of useful image search queries and beautiful image search queries, as well as negative examples that are neither useful nor beautiful.

As also shown, the instructions 422 include additional guidelines, including not returning the same or similar images as the one engaged (e.g., the candidate image), using the metadata provided but more heavily weighting the image itself, being in a common language, and not including inappropriate, insensitive, or offensive results. Furthermore, as shown, the additional guidelines include instructions to generate a summary sentence of a user's interest and provide the short sentence in the results. The guidelines also include a specified output format. The instructions 422 are shown by way of example, and the diverse retrieval system 210 may include additional and/or different instructions in an image query generation prompt.

In some instances, the image query generation prompt 420 also includes a test case section 424. For example, the test case section 424 includes a request sub-section 426 and, in some cases, a response sub-section (not shown). In various implementations, the test case section 424 outlines specific conditions under which the responses will be evaluated. The request sub-section 426 outlines what is being sent to the system (e.g., input formats) to trigger a specific behavior or functionality. As shown, the request sub-section 426 includes an example format for metadata 428. When included, a response sub-section may describe the expected behavior after the request is processed and/or the expected output.

Returning to FIG. 4A, act 406 includes the diverse retrieval system 210 providing the image query generation prompt to the visual-based generative AI model 230. In addition, the diverse retrieval system 210 provides the candidate image and corresponding metadata. In various implementations, the diverse retrieval system 210 provides supplemental or additional prompts, such as system prompts and/or responsible AI prompts.

In various implementations, the diverse retrieval system 210 generates and provides a different prompt when generating a different content type mapping. For example, when generating diverse image search queries based on candidate webpages or candidate queries, the diverse retrieval system 210 provides different instructions. In these instances, the generative AI model may be a text-based generative AI model. In some implementations, the diverse retrieval system 210 provides a uniform prompt that covers generating diverse image search queries from multiple input types or formats.

Act 408 includes the visual-based generative AI model 230 following instructions in the prompt to generate diverse image search queries. For example, the visual-based generative AI model 230 analyzes the candidate images for visual contexts and generates a diverse set of image search queries following the instructions in the image query generation prompt based on the visual content and the metadata. For instance, the visual-based generative AI model 230 generates a set of ten image query generation prompts for the candidate image.

Act 410 includes the visual-based generative AI model 230 returning the generated diverse image search queries for the candidate image to the diverse retrieval system 210. In various implementations, the visual-based generative AI model 230 provides the diverse image search queries in the output format specified in the prompt. The visual-based generative AI model 230 can also provide additional information requested in the prompt, such as a user interest summary sentence for each candidate image.

Act 412 includes the diverse retrieval system 210 performing responsible AI verification to remove inappropriate or unapproved search queries. For example, the diverse retrieval system 210 inspects the diverse image search queries to ensure that each query adheres to the established safeguards for responsible AI generation.

In various implementations, the diverse retrieval system 210 performs one or more acts from the series of acts 400 as part of a batch. For example, the diverse retrieval system 210 provides multiple candidate images to the visual-based generative AI model 230 along with one or more diverse image search queries. In some instances, the visual-based generative AI model 230 processes each of the candidate images concurrently and returns the generated queries as a batch.

Additionally, in various implementations, the diverse retrieval system 210 repeats the one or more acts from the series of acts 400 for a candidate image. For example, by updating the image query generation prompt and/or the visual-based generative AI model 230, the diverse retrieval system 210 updates the diverse image search queries for the candidate image. In some implementations, the diverse retrieval system 210 runs a regular update for a candidate image with the same and/or updated metadata.

As mentioned above, FIG. 5 provides additional details about discovering image search results and selecting a subset of search result images. In particular, FIG. 5 illustrates an example sequence flow diagram for obtaining a selected set of images corresponding to a candidate image according to some implementations.

As shown, FIG. 5 includes communications between the diverse retrieval system 210 and the image search system 206 of the image retrieval system 204 to identify image search results from the generate diverse image search queries. More specifically, FIG. 5 includes a series of acts 500 for actions performed by the diverse retrieval system 210 or the image search system 206 (following the directions of the diverse retrieval system 210).

The series of acts 500 includes act 502 of the diverse retrieval system 210 providing the set of diverse image search queries to an image search system. In some instances, the diverse retrieval system 210 provides each diverse image search query in a separate call. In some implementations, the diverse retrieval system 210 provides the diverse image search queries together in a batch.

Act 504 includes the image search system 206 utilizing the diverse image search queries to generate image search results. In various implementations, the image search system 206 executes, applies, and/or runs each of the diverse image search queries to discover retrievable images and obtain image search results. For example, the image search system 206 is an image scraper that uses application programming interface (API) calls to identify image search results for each of the diverse image search queries. In various implementations, the image search system 206 further diversifies the image search queries to identify a further diverse range of image results.

In various implementations, the image search system 206 identifies a large set of image search results for each image search query. In some instances, the image search system 206 limits the number of image results identified for each query. Additionally, in some instances, the image search system 206 identifies metadata for each image in the image search results.

Act 506 includes the image search system 206 returning the generated diverse image search queries for the candidate image to the diverse retrieval system 210. For example, the image search system 206 returns a list of image identifiers corresponding to images in the image search results. The image identifiers can link to the images and their corresponding metadata. In some implementations, the image search system 206 provides the images to the diverse retrieval system 210.

Act 508 includes the diverse retrieval system 210 selecting a subset of the images from the image search results for the candidate image. In various implementations, the diverse retrieval system 210 orders or ranks the images in the returned image search results for a diverse image search query. For example, the diverse retrieval system 210 ranks the images based on relevance, diversity, freshness, source reliability, and/or other factors.

Once ordered or ranked, the diverse retrieval system 210 can select a subset of the image search results for a diverse image search query, such as the top-n images (e.g., 10, 15, 20, 25, 50, 100). The diverse retrieval system 210 can repeat this process for each image search result set corresponding to each of the diverse image search queries. By doing so, the diverse retrieval system 210 obtains a controlled number of images from the image search results for each diverse image search query corresponding to a candidate image.

Act 510 includes the diverse retrieval system 210 performing responsible AI verification to remove inappropriate or unapproved selected images. For example, the diverse retrieval system 210 inspects the images in each of the subsets of image results to ensure that each image adheres to the established safeguards for responsible AI generation.

As mentioned above, FIG. 6 provides details about generating a diverse image relationship table. In particular, FIG. 6 illustrates an example diagram of an image-to-image diverse image relationship table that maps a candidate image to the selected set of search result images according to some embodiments.

As mentioned above, the diverse retrieval system 210 generates a diverse image relationship table for the candidate image that maps the candidate image to the selected subsets of search result images. The diverse retrieval system 210 may create a diverse image relationship table for multiple candidate images. Furthermore, the diverse retrieval system 210 may create a diverse image relationship database or data store that includes the tables for the multiple candidate images. The diverse retrieval system 210 may continually add new diverse image relationship tables for additional candidate images to the diverse image relationship database.

In various implementations, the diverse image relationship table is an image-to-image table where a candidate image maps to subsets of corresponding diverse search result images. In some implementations, the diverse image relationship table is a query-to-image table, a website-to-image table, or another content type-to-image table.

To illustrate, FIG. 6 includes an image-to-image diverse image relationship table 600. The image-to-image diverse image relationship table 600 includes a candidate image 610 represented by a candidate image identifier 612. The image-to-image table also includes mapped images (e.g., selected search result images). As shown, the table includes a first mapped image 620a represented by a first mapped image identifier 622a, a second mapped image 620b represented by a second mapped image identifier 622b, and a third mapped image 620c represented by a third mapped image identifier 622c.

In addition, for each mapped image, the table can also include metadata and/or a corresponding query. For example, the first mapped image 620a is linked to first mapped image metadata 624a and/or a first mapped image query 626a. Similarly, the second mapped image 620b is linked to second mapped image metadata 624b and/or a second mapped image query 626b, and the third mapped image 620c is linked to third mapped image metadata 624c and/or a third mapped image query 626c.

As mentioned above, image metadata can include a page title, source links, image context, and/or descriptions, and other information corresponding to a mapped image. In various implementations, the query can include the diverse image search query used to discover and retrieve the mapped image or content related to the image query.

In some implementations, the image-to-image table includes identifiers or index tokens for data stored elsewhere. For example, the candidate image identifier 612 is mapped to the first mapped image identifier 622a, the second mapped image identifier 622b, and the third mapped image identifier 622c. The metadata and/or the query may also be represented as identifiers.

As mentioned above, the diverse retrieval system 210 can update a diverse image relationship table when new search result images corresponding to the candidate image are found and selected. For instance, an updated prompt, an updated or revised generative AI model, modifications to how the image search system discovers images, or the passage of a specified time interval may cause the diverse retrieval system 210 to select new and/or different search result images for the candidate image.

As mentioned above, FIG. 7 provides additional details about utilizing diverse image relationship tables. In particular, FIG. 7 illustrates an example state diagram for using the diverse image relationship table to retrieve selected images mapped to a content item in response to an image retrieval request according to some implementations.

As shown, FIG. 7 includes a series of acts 700 performed by the diverse retrieval system 210. The series of acts 700 includes act 702 of receiving an image identifier for an image from an image retrieval system. For instance, a user inputs an image search query to the image retrieval system, or another system provides an image search request to the image retrieval system. In response, the image retrieval system identifies a query image (e.g., a candidate image). For example, the image retrieval system uses the image search system to identify a set of image search results and selects one of the images as a query image. In some instances, the image retrieval system uses the image search system to identify a user-selected or clicked image from a search result as a query image. The image retrieval system may then provide the image identifier of the query image to the diverse retrieval system 210 to quickly and accurately retrieve a diverse set of images for the query image.

Act 704 includes the diverse retrieval system 210 determining whether the image identifier is in the diverse image relationship table. For instance, the diverse retrieval system 210 calls or queries the diverse image relationship database to check whether the image identifier is associated with a diverse image relationship table within the database. If the database includes a diverse image relationship table for the image identifier, the diverse retrieval system 210 advances to act 706. Otherwise, the diverse retrieval system 210 performs act 710.

Act 706 includes the diverse retrieval system 210 identifying image identifiers for the images mapped to the image identifier of the query image. In various implementations, upon determining that the requested image identifier is a processed candidate image that has a diverse image relationship table in the diverse image relationship database, the diverse retrieval system 210 accesses the diverse image relationship table for the query image and identifies the mapped images in the table. In various implementations, the diverse retrieval system 210 obtains some or all of the image identifiers for the mapped images from the diverse image relationship table.

Act 708 includes the diverse retrieval system 210 returning the mapped image identifiers to the image retrieval system. For instance, the diverse retrieval system 210 returns the image identifiers for the mapped images and/or the mapped images for the query image to the image retrieval system. Because the diverse retrieval system 210 may generate the diverse image relationship tables offline, the retrieval process recalls the mapped images quickly, requiring few computational steps.

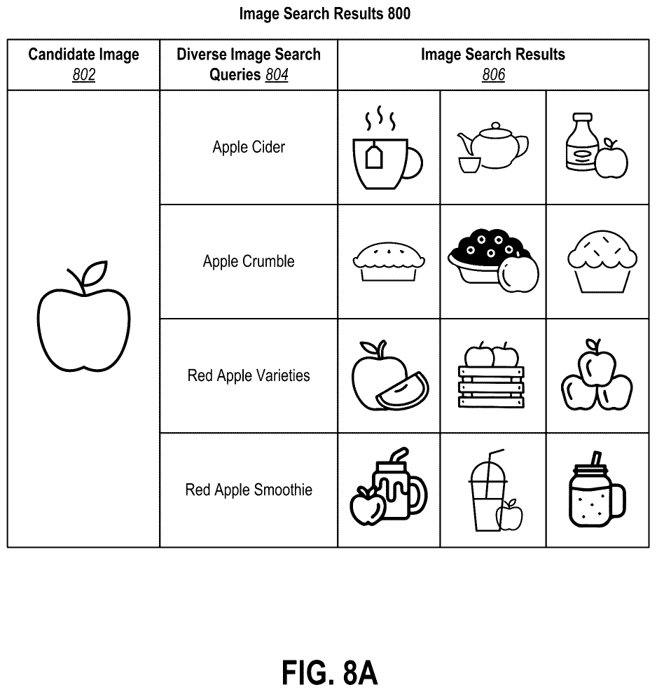

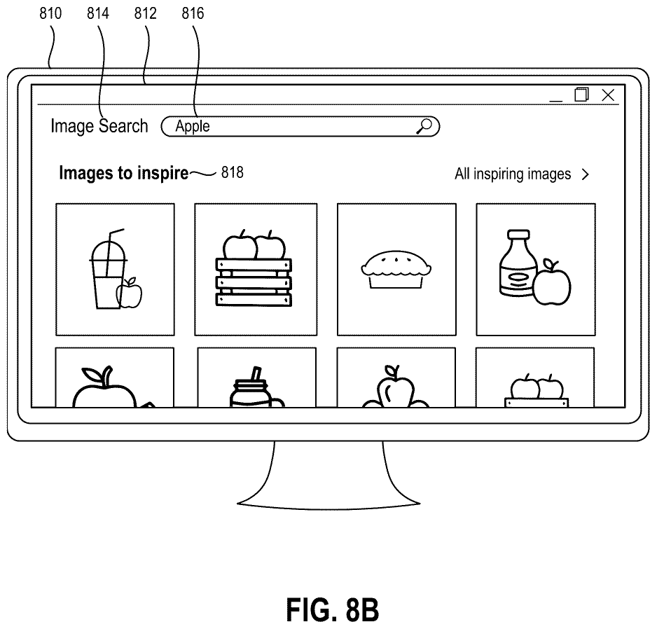

In various implementations, the diverse retrieval system 210 also provides corresponding image metadata and/or other image information for the mapped images from the diverse image relationship table for the query image. The image retrieval system may provide the mapped images in response to the user or system image query, as described below in connection with FIG. 8B.

Returning to act 704, in some instances, the diverse retrieval system 210 determines that the image identifier of the query image is not the subject or index of a diverse image relationship table. Accordingly, when a diverse image relationship table is not found for the query image, the diverse retrieval system 210 can identify a proxy candidate image with a diverse image relationship table to obtain diverse image results.

To illustrate, act 710 includes the diverse retrieval system 210 generating an embedding for the query image within an image embedding space that includes image embeddings for other candidate images with diverse relationship mappings. For example, the diverse retrieval system 210 generates a feature vector embedding for the query image. Additionally, the diverse retrieval system 210 may create embeddings for each processed candidate image with diverse image relationship tables in the diverse image relationship database. The diverse retrieval system 210 may add the embedding of the query image to the embedding space of the processed candidate image embeddings.

Act 712 includes the diverse retrieval system 210 determining a proxy candidate image in the embedding space within a threshold distance. In various implementations, the diverse retrieval system 210 identifies one or more embeddings for processed candidate images that are near the embedding (e.g., within a predefined distance vector threshold) for the query image. In some implementations, the diverse retrieval system 210 utilizes a nearest neighbor algorithm, such as an approximate nearest neighbor algorithm or another nearest neighbor algorithm, such as K-NN to identify processed candidate image embeddings that are closer to or near the query image embedding in the embedding space.

Additionally, the diverse retrieval system 210 may select one of the identified processed candidate images as a proxy candidate image for the query image. For example, the diverse retrieval system 210 selects the nearest proxy candidate image in the embedding space or the candidate image embedding that has the highest correlation score with the query image embedding. In some instances, the diverse retrieval system 210 selects a proxy candidate image having a correlation score with the query image embedding that meets (e.g., is above) a predefined distance threshold value.

Act 714 includes the diverse retrieval system 210 identifying proxy image identifiers for images mapped to the proxy candidate image. In various implementations, once a proxy candidate image is selected, the diverse retrieval system 210 may access the diverse image relationship table for the proxy candidate image. Additionally, the diverse retrieval system 210 may retrieve the mapped images with the diverse image relationship table for the proxy candidate image. In particular, the diverse retrieval system 210 retrieves the image identifiers (proxy image identifiers) for the images mapped to the proxy candidate image.

Act 716 includes the diverse retrieval system 210 returning the proxy mapped image identifiers to the image retrieval system. For instance, the diverse retrieval system 210 returns the image identifiers of the mapped images and/or the mapped images for the proxy candidate image to the image retrieval system. In many implementations, the process of identifying a proxy candidate image and returning proxy mapped images occurs in real time, as only simple computational steps are needed to identify and recall a diverse set of proxy mapped images.

In various implementations, the diverse retrieval system 210 may associate the query image with the proxy candidate image until a diverse image relationship table for the query image can be generated and added to the diverse image relationship database. In some implementations, the diverse retrieval system 210 does not associate the query image with the proxy candidate image within the diverse image relationship table or diverse image relationship database, as subsequent calls of the query image may identify a different proxy candidate image (if a candidate image for the query image has not been created).

As mentioned above, FIGS. 8A-8B provide an example of a diverse image set for a candidate image and of providing selected images from the diverse set to a user in response to a user query. In particular, FIGS. 8A-B illustrate an example for selected image search results of a candidate image and of providing selected images mapped to a candidate image within a graphical user interface in response to an image retrieval request.

FIG. 8A includes an example of image search results 800. As shown, the image search results 800 include a candidate image 802, diverse image search queries 804, and image search results 806. For example, the diverse retrieval system 210 selects and/or identifies an image of a red apple as the candidate image 802. In response, the diverse retrieval system 210 generates and/or provides an image query generation prompt to a visual-based generative AI model to generate diverse image search queries for the candidate image of the red apple.

As shown, the visual-based generative AI model generates diverse image search queries 804 that include queries such as “apple cider,” “apple crumble,” “red apple varieties,” and “red apple smoothie.” The diverse retrieval system 210 provides the diverse image search queries 804 to an image search system, which searches for each of the diverse image search queries to generate the image search results 806. As shown, the image search results 806 include various diverse example images corresponding to the image search queries.

Furthermore, as described above, the diverse retrieval system 210 can all the image search results 806 to a diverse image relationship table for the candidate image 802. For instance, the diverse retrieval system 210 selects a subset of the image search results 806 to map to the candidate image 802 within a diverse image relationship table.

FIG. 8B provides an example of providing images from the diverse image relationship table for the candidate image within a graphical user interface. As shown, FIG. 8B includes a client device 810 with a graphical user interface that displays a client application 812. For example, the client application 812 is a web browser application. As shown, the client application 812 shows a user accessing an image search website 814 associated with an image retrieval system (e.g., an image search engine). The image search website 814 includes a query text field 816, where a user can request image results. For example, the query text field 816 shows a query for images of an “apple.” In response, the image retrieval system can identify a query image (e.g., a candidate image), such as the candidate image 802 shown in FIG. 8A above.

Additionally, in response to receiving the query image of the red apple from the image retrieval system, the diverse retrieval system 210 retrieves and provides a diverse image set, including the images shown on the image search website 814. As shown, the image search website 814 displays diverse images 818 obtained from the diverse image relationship table corresponding to the candidate image. As described above, the diverse images 818 are relevant yet distinct and diverse from the query image. In some implementations, the diverse retrieval system 210 receives different categories of diverse images from a diverse image relationship table to provide to the image retrieval system for display to a user.

In some instances, the diverse retrieval system 210 provides the diverse images 818 to a user based on user profile images and/or past image queries. For example, the diverse images 818 are displayed before the image search website 814 receives a user query. In some implementations, in response to a user selecting a search result image, the image retrieval system provides the selected image to the diverse retrieval system 210 as a query image, and the diverse retrieval system 210, in response, retrieves and displays the diverse images 818.

As shown, the image search website 814 in FIG. 8B provides an illustrative example of how the diverse retrieval system 210 can provide diverse images in response to a query image. By providing diverse images, the diverse retrieval system 210 and/or the image retrieval system can quickly, accurately, and efficiently provide image search results that increase user engagement and interaction. Indeed, researchers have found that the diverse retrieval system 210 increases user engagement compared to current image retrieval systems.

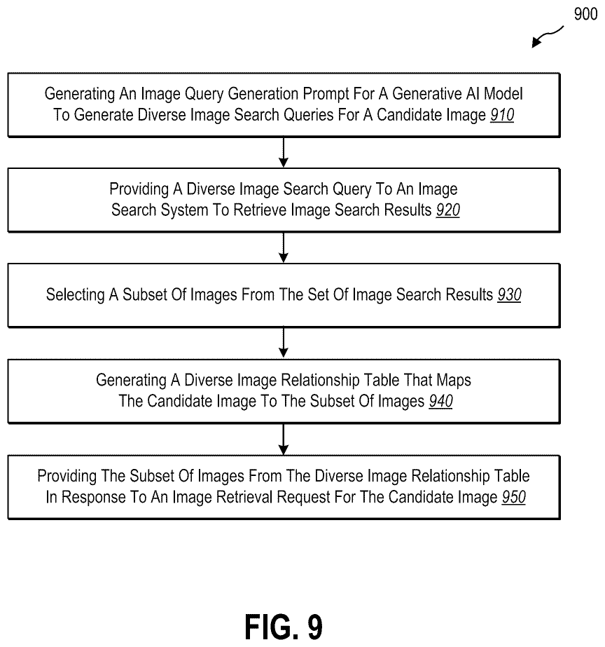

Turning now to FIG. 9, these figures each illustrate an example flowchart that includes a series of acts for using the diverse retrieval system. In particular, FIG. 9 illustrates an example series of acts in a computer-implemented method for generating one or more image relationship tables using one or more generative AI models according to some implementations.

While FIG. 9 illustrates acts according to one or more implementations, alternative implementations may omit, add to, reorder, and/or modify any of the acts shown. Furthermore, the acts of FIG. 9 can each be performed as part of a method (e.g., a computer-implemented method). Alternatively, a computer-readable medium can include instructions that, when executed by a processing system having a processor, cause a computing device to perform each of the acts of FIG. 9. In some implementations, a system (e.g., a processing system having a processor and a computer memory including instructions that, when executed by the processing system, cause the system to perform various actions or steps) can perform each of the acts of FIG. 9.

As shown in FIG. 9, the series of acts 900 includes act 910 of generating an image query generation prompt for a generative AI model to generate diverse image search queries for a candidate image. For instance, in example implementations, act 910 involves generating an image query generation prompt with instructions for a generative AI model to generate a set of diverse image search queries corresponding to a candidate image and candidate metadata associated with the candidate image, wherein a diverse image search query returns image results related to the candidate image and visually different or distinct from the candidate image.

In one or more implementations, act 910 includes generating an image query generation prompt with instructions for the visual-based generative AI model to generate a set of diverse image search queries corresponding to a candidate image and candidate metadata associated with the candidate image, where a diverse image search query returns an image search result related to the candidate image and visually different or distinct from the candidate image. In various implementations, with act 910, the generative AI model is a visual-based generative AI model that determines visual context information from input images. In some instances, the visual-based generative AI model utilizes visual context information from the candidate image to generate the first diverse image search query. In some instances, a useful image result includes an image with information located within the image. In various implementations, a beautiful image result includes an aesthetically pleasing image.

In various implementations, the image query generation prompt includes context as an image recommendation system, the number of image search queries, examples of useful image search queries, examples of beautiful image search queries, or formatting guidelines for an outputted set of diverse image queries. In some implementations, act 910 includes determining a candidate image and candidate metadata associated with the candidate image from a large image dataset.

In various implementations, act 910 includes identifying a large image dataset, ordering images in the large image dataset based on one or more factors, determining the candidate image from the large image dataset based on image ordering, and obtaining the candidate metadata associated, wherein the candidate metadata includes a page title of a web page linked to the candidate image. In some instances, act 910 includes ordering the images within the large image dataset by ranking images in the large image dataset based on interaction counts and selecting the candidate image based on image ranking. In various implementations, ordering the images within the large image dataset includes grouping the images in the large image dataset into embedding clusters, identifying a cluster center for an embedding cluster, and selecting an image near the cluster center as the candidate image.

As further shown in FIG. 9, the series of acts 900 includes act 920 of providing a diverse image search query to an image search system to retrieve image search results. For instance, in some implementations, act 920 involves providing the first diverse image search query to an image search system that retrieves image search results using search queries for a first diverse image search query received from the generative AI model. In one or more implementations, act 920 includes providing the set of diverse image search queries to the image search system to identify sets of image search results from the image search system. In some implementations, act 920 includes filtering out an inappropriate or unapproved diverse image retrieval query from the set of diverse image search queries before providing the set of diverse image search queries to the image search system.

As further shown in FIG. 9, the series of acts 900 includes act 930 of selecting a subset of images from the set of image search results. For instance, in some implementations, act 930 involves selecting a subset of images from the set of image search results in response to receiving a set of image search results from the image search system based on the first diverse image search query. In one or more implementations, act 930 includes selecting a subset of images from the sets of image search results in response to receiving the sets of image search results.

As further shown in FIG. 9, the series of acts 900 includes act 940 of generating a diverse image relationship table that maps the candidate image to the subset of images. For instance, in example implementations, act 940 involves generating a diverse image relationship table that includes an image identifier for the candidate image mapped to mapped image identifiers for the subset of images. In one or more implementations, act 940 includes generating a diverse image relationship table that includes the candidate image mapped to the subset of images in response to receiving the sets of image search results. In one or more implementations, act 940 includes filtering out an inappropriate or unapproved image from the subset of images before generating the diverse image relationship table. In various implementations, generating the diverse image relationship table occurs offline.

As further shown in FIG. 9, the series of acts 900 includes act 950 of providing the subset of images from the diverse image relationship table in response to an image retrieval request for the candidate image. For instance, in example implementations, act 950 involves providing the mapped image identifiers for the subset of images from the diverse image relationship table in response to detecting an image retrieval request for the candidate image. In various implementations, act 950 includes detecting a selection of the candidate image by a user; based on the selection of the candidate image, receiving the image identifier for the candidate image; identifying the image identifier for the candidate image within the diverse image relationship table; and providing the mapped image identifiers for the subset of images from the diverse image relationship table mapped to the image identifier for the candidate image.

In some instances, act 950 includes determining that the query image is absent from the diverse image relationship table based on receiving an image retrieval request for a query image, determining the candidate image as the nearest image in embedding space to the query image, and providing the mapped image identifiers for the subset of images from the diverse image relationship table mapped to the image identifier for the candidate image in response to the image retrieval request. In one or more implementations, providing the mapped image identifiers for the subset of images from the diverse image relationship table occurs in real time in response to an image retrieval request for the candidate image without calling or invoking the generative AI model.

In some implementations, the series of acts 900 includes additional acts. For example, the series of acts 900 includes generating a query-to-image relationship table that maps an additional set of mapped image identifiers to a candidate query. In various implementations, the series of acts 900 includes generating a webpage-to-image relationship table that maps an additional set of mapped image identifiers to a candidate webpage.

FIG. 10 illustrates certain components that may be included within a computer system 1000. The computer system 1000 may be used to implement the various computing devices, components, and systems described herein (e.g., by performing computer-implemented instructions). As used herein, a “computing device” refers to electronic components that perform a set of operations based on a set of programmed instructions. Computing devices include groups of electronic components, client devices, server devices, etc.

In various implementations, the computer system 1000 represents one or more of the client devices, server devices, or other computing devices described above. For example, the computer system 1000 may refer to various types of network devices capable of accessing data on a network, a cloud computing system, or another system. For instance, a client device may refer to a mobile device such as a mobile telephone, a smartphone, a personal digital assistant (PDA), a tablet, a laptop, or a wearable computing device (e.g., a headset or smartwatch). A client device may also refer to a non-mobile device such as a desktop computer, a server node (e.g., from another cloud computing system), or another non-portable device.

The computer system 1000 includes a processing system including a processor 1001. The processor 1001 may be a general-purpose single- or multi-chip microprocessor (e.g., an Advanced Reduced Instruction Set Computer (RISC) Machine (ARM)), a special-purpose microprocessor (e.g., a digital signal processor (DSP)), a microcontroller, a programmable gate array, etc. The processor 1001 may be referred to as a central processing unit (CPU) and may cause computer-implemented instructions to be performed. Although the processor 1001 shown is just a single processor in the computer system 1000 of FIG. 10, in an alternative configuration, a combination of processors (e.g., an ARM and DSP) could be used.

The computer system 1000 also includes memory 1003 in electronic communication with the processor 1001. The memory 1003 may be any electronic component capable of storing electronic information. For example, the memory 1003 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers, and so forth, including combinations thereof.

The instructions 1005 and the data 1007 may be stored in the memory 1003. The instructions 1005 may be executable by the processor 1001 to implement some or all of the functionality disclosed herein. Executing the instructions 1005 may involve the use of the data 1007 that is stored in the memory 1003. Any of the various examples of modules and components described herein may be implemented, partially or wholly, as instructions 1005 stored in memory 1003 and executed by the processor 1001. Any of the various examples of data described herein may be among the data 1007 that is stored in memory 1003 and used during the execution of the instructions 1005 by the processor 1001.

A computer system 1000 may also include one or more communication interface(s) 1009 for communicating with other electronic devices. The one or more communication interface(s) 1009 may be based on wired communication technology, wireless communication technology, or both. Some examples of the one or more communication interface(s) 1009 include a Universal Serial Bus (USB), an Ethernet adapter, a wireless adapter that operates according to an Institute of Electrical and Electronics Engineers (IEEE) 1002.11 wireless communication protocol, a Bluetooth® wireless communication adapter, and an infrared (IR) communication port.

A computer system 1000 may also include one or more input device(s) 1011 and one or more output device(s) 1013. Some examples of the one or more input device(s) 1011 include a keyboard, mouse, microphone, remote control device, button, joystick, trackball, touchpad, and light pen. Some examples of the one or more output device(s) 1013 include a speaker and a printer. A specific type of output device that is typically included in a computer system 1000 is a display device 1015. The display device 1015 used with implementations disclosed herein may utilize any suitable image projection technology, such as liquid crystal display (LCD), light-emitting diode (LED), gas plasma, electroluminescence, or the like. A display controller 1017 may also be provided, for converting data 1007 stored in the memory 1003 into text, graphics, and/or moving images (as appropriate) shown on the display device 1015.

The various components of the computer system 1000 may be coupled together by one or more buses, which may include a power bus, a control signal bus, a status signal bus, a data bus, etc. For clarity, the various buses are illustrated in FIG. 10 as a bus system 1019.

This disclosure describes a subjective data application system in the framework of a network. In this disclosure, a “network” refers to one or more data links that enable electronic data transport between computer systems, modules, and other electronic devices. A network may include public networks such as the Internet as well as private networks. When information is transferred or provided over a network or another communication connection (either hardwired, wireless, or both), the computer correctly views the connection as a transmission medium. Transmission media can include a network and/or data links that carry required program code in the form of computer-executable instructions or data structures, which can be accessed by a general-purpose or special-purpose computer. Combinations of the above are also included within the scope of computer-readable media.

In addition, the network described herein may represent a network or a combination of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which one or more computing devices may access the various systems described in this disclosure. Indeed, the networks described herein may include one or multiple networks that use one or more communication platforms or technologies for transmitting data. For example, a network may include the Internet or other data link that enables transporting electronic data between respective client devices and components (e.g., server devices and/or virtual machines thereon) of the cloud computing system.

Further, upon reaching various computer system components, program code means in the form of computer-executable instructions or data structures can be transferred automatically from transmission media to non-transitory computer-readable storage media (devices), or vice versa. For example, computer-executable instructions or data structures received over a network or data link can be buffered in random-access memory (RAM) within a network interface module (NIC), and then it is eventually transferred to computer system RAM and/or to less volatile computer storage media (devices) at a computer system. Thus, it should be understood that computer-readable storage media (devices) can be included in computer system components that also (or even primarily) utilize transmission media.

Computer-executable instructions include instructions and data that, when executed by a processor, cause a general-purpose computer, special-purpose computer, or special-purpose processing device to perform a certain function or group of functions. In some implementations, computer-executable and/or computer-implemented instructions are executed by a general-purpose computer to turn the general-purpose computer into a special-purpose computer implementing elements of the disclosure. The computer-executable instructions may include, for example, binaries, intermediate format instructions such as assembly language, or even source code. Although the subject matter has been described in language specific to structural features and/or methodological acts, it is to be understood that the subject matter defined in the appended claims is not necessarily limited to the features or acts described above. Rather, the described features and acts are disclosed as example forms of implementing the claims.

Those skilled in the art will appreciate that the disclosure may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or a combination of hardwired and wireless data links) through a network, both perform tasks. In a distributed system environment, program modules may be located in both local and remote memory storage devices.

The techniques described herein may be implemented in hardware, software, firmware, or any combination thereof unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium, including instructions that, when executed by at least one processor, perform one or more of the methods described herein (including computer-implemented methods). The instructions may be organized into routines, programs, objects, components, data structures, etc., which may perform particular tasks and/or implement particular data types, and which may be combined or distributed as desired in various implementations.

Computer-readable media can be any available media that can be accessed by a general-purpose or special-purpose computer system. Computer-readable media that store computer-executable instructions are non-transitory computer-readable storage media (devices). Computer-readable media that carry computer-executable instructions are transmission media. Thus, by way of example, implementations of the disclosure can include at least two distinctly different kinds of computer-readable media: non-transitory computer-readable storage media (devices) and transmission media.

As used herein, computer-readable storage media (devices) may include RAM, ROM, EEPROM, CD-ROM, solid-state drives (SSDs) (e.g., based on RAM), Flash memory, phase-change memory (PCM), other types of memory, other optical disk storage, magnetic disk storage or other magnetic storage devices, or any other medium which can be used to store desired program code means in the form of computer-executable instructions or data structures and which can be accessed by a general-purpose or special-purpose computer.

The steps and/or actions of the methods described herein may be interchanged with one another without departing from the scope of the claims. In other words, unless a specific order of steps or actions is required for the proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a data repository, or another data structure), ascertaining, and the like. Also, “determining” can include receiving (e.g., receiving information), accessing (e.g., accessing data in a memory), and the like. Also, “determining” can include resolving, selecting, choosing, establishing, and the like.

The terms “comprising,” “including,” and “having” are intended to be inclusive and mean that there may be additional elements other than the listed elements. Additionally, it should be understood that references to “one implementation” or “implementations” of the present disclosure are not intended to be interpreted as excluding the existence of additional implementations that also incorporate the recited features. For example, any element or feature described concerning an implementation herein may be combinable with any element or feature of any other implementation described herein, where compatible.

The present disclosure may be embodied in other specific forms without departing from its spirit or characteristics. The described implementations are to be considered illustrative and not restrictive. The scope of the disclosure is indicated by the appended claims rather than by the foregoing description. Changes that come within the meaning and range of equivalency of the claims are to be embraced within their scope.

What is claimed is:

1. A computer-implemented method for generating one or more image relationship tables using one or more generative artificial intelligence (AI) models, comprising:
generating an image query generation prompt with instructions for a generative AI model to generate a set of diverse image search queries corresponding to a candidate image and candidate metadata associated with the candidate image, wherein a diverse image search query returns image results related to the candidate image and visually different from the candidate image;
for a first diverse image search query received from the generative AI model, providing the first diverse image search query to an image search system that retrieves image search results using search queries;
in response to receiving a set of image search results from the image search system based on the first diverse image search query, selecting a subset of images from the set of image search results; and
generating a diverse image relationship table that includes an image identifier for the candidate image mapped to mapped image identifiers for the subset of images.

2. The computer-implemented method of claim 1, wherein:
the generative AI model is a visual-based generative AI model that determines visual context information from input images; and
the visual-based generative AI model utilizes visual context information from the candidate image to generate the first diverse image search query.

3. The computer-implemented method of claim 1, further comprising:
detecting a selection of the candidate image by a user;
based on the selection of the candidate image, receiving the image identifier for the candidate image;
identifying the image identifier for the candidate image within the diverse image relationship table; and
providing the mapped image identifiers for the subset of images from the diverse image relationship table mapped to the image identifier for the candidate image.

4. The computer-implemented method of claim 1, further comprising:
based on receiving an image retrieval request for a query image, determining that the query image is absent from the diverse image relationship table;
determining the candidate image as a nearest image in embedding space to the query image; and
providing the mapped image identifiers for the subset of images from the diverse image relationship table mapped to the image identifier for the candidate image in response to the image retrieval request.

5. The computer-implemented method of claim 1, wherein:
a useful image result includes an image with information located within the image; and
a beautiful image result includes an image that is aesthetically pleasing.

6. The computer-implemented method of claim 1, wherein:
generating the diverse image relationship table occurs offline; and
providing the mapped image identifiers for the subset of images from the diverse image relationship table occurs in real time in response to an image retrieval request for the candidate image without calling the generative AI model.

7. The computer-implemented method of claim 1, further comprising:
filtering out an inappropriate or unapproved diverse image retrieval query from the set of diverse image search queries before providing the set of diverse image search queries to the image search system; and
filtering out an inappropriate or unapproved image from the subset of images before generating the diverse image relationship table.

8. The computer-implemented method of claim 1, wherein the image query generation prompt includes:
context to search for images for a perspective of an image recommendation system;
a number of image search queries;
examples of useful image search queries;
examples of beautiful image search queries; and
formatting guidelines for an outputted set of diverse image queries.

9. The computer-implemented method of claim 1, further comprising:
identifying a large image dataset;
ordering images in the large image dataset based on one or more factors;
determining the candidate image from the large image dataset based on image ordering; and
obtaining the candidate metadata associated, wherein the candidate metadata includes a page title of a web page linked to the candidate image.

10. The computer-implemented method of claim 9, further comprising ordering the images within the large image dataset by:
ranking images in the large image dataset based on interaction counts; and
selecting the candidate image based on image ranking.

11. The computer-implemented method of claim 9, further comprising ordering the images within the large image dataset by:
grouping the images in the large image dataset into embedding clusters;
identifying a cluster center for an embedding cluster; and
selecting an image near the cluster center as the candidate image.

12. A system comprising:
a processor; and
a computer memory including:
a visual-based generative artificial intelligence (AI) model;
an image search system that retrieves image search results using search queries; and
instructions that, when executed by the processor, cause the system to carry out operations comprising:
generating an image query generation prompt with instructions for the visual-based generative AI model to generate a set of diverse image search queries corresponding to a candidate image and candidate metadata associated with the candidate image, wherein a diverse image search query returns an image search result related to the candidate image and visually different from the candidate image;
providing the set of diverse image search queries to the image search system to identify sets of image search results from the image search system;
in response to receiving the sets of image search results, selecting a subset of images from the sets of image search results; and
generating a diverse image relationship table that includes the candidate image mapped to the subset of images.

13. The system of claim 12, further comprising additional instructions that, when executed by the processor, cause the system to carry out operations comprising:
based on receiving an image retrieval request for a query image, determining that the query image is absent from the diverse image relationship table;
determining the candidate image as a nearest image in embedding space to the query image; and
providing the subset of images from the diverse image relationship table mapped to the candidate image in response to the image retrieval request.

14. The system of claim 12, further comprising additional instructions that, when executed by the processor, cause the system to carry out operations comprising determining a candidate image and candidate metadata associated with the candidate image from a large image dataset.

15. The system of claim 12, further comprising additional instructions that, when executed by the processor, cause the system to carry out operations comprising providing the subset of images from the diverse image relationship table in response to detecting an image retrieval request for the candidate image.

16. The system of claim 12, wherein generating the diverse image relationship table occurs offline.

17. The system of claim 12, wherein providing the subset of images from the diverse image relationship table occurs in real time in response to an image retrieval request for the candidate image without calling the visual-based generative AI model.

18. A computer-implemented method for generating one or more image relationship tables using one or more generative artificial intelligence (AI) models, comprising:
determining a candidate image and candidate metadata associated with the candidate image from a large image dataset;
generating an image query generation prompt with instructions for a generative AI model to generate a set of diverse image search queries corresponding to a candidate image and candidate metadata associated with the candidate image, wherein a diverse image search query returns image results related to the candidate image and visually different from the candidate image;
for a first diverse image search query received from the generative AI model, providing the first diverse image search query to an image search system that retrieves image search results using search queries;
in response to receiving a set of image search results from the image search system based on the first diverse image search query, selecting a subset of images from the set of image search results;
generating a diverse image relationship table that includes an image identifier for the candidate image mapped to mapped image identifiers for the subset of images; and
providing the mapped image identifiers for the subset of images from the diverse image relationship table in response to detecting an image retrieval request for the candidate image.

19. The computer-implemented method of claim 18, further comprising generating a query-to-image relationship table that maps an additional set of mapped image identifiers to a candidate query.

20. The computer-implemented method of claim 18, further comprising generating a webpage-to-image relationship table that maps an additional set of mapped image identifiers to a candidate webpage.
